(19) United States
(12) Patent Application Publication
(10) Pub. No.: US 2019/0056998 A1
(43) Pub. Date: Feb. 21, 2019

(54) LARGE SCALE DISPERSED STORAGE NETWORK USING SET TOP BOXES AND CENTRALIZED CONTROL

(71) Applicant: International Business Machines Corporation, Armonk, NY (US)

(72) Inventors: Gary W. Grube, Barrington Hills, IL (US); Timothy W. Markison, Mesa, AZ (US)

(21) Appl. No.: 16/169,571

(22) Filed: Oct. 24, 2018

Related U.S. Application Data
(63) Continuation-in-part of application No. 15/956,984, filed on Apr. 19, 2018.
Application No. 15/956,984 is a continuation-in-part of application No. 14/328,904, filed on Jul. 11, 2014, now Pat. No. 9,996,548.
Application No. 14/328,904 is a continuation-in-part of application No. 14/230,253, filed on Mar. 31, 2014, now Pat. No. 9,268,641.
Application No. 14/230,253 is a continuation of application No. 12/862,878, filed on Aug. 25, 2010, now Pat. No. 8,688,907.
(60) Provisional application No. 61/264,504, filed on Nov. 25, 2009.

(51) Int. Cl. G06F 11/10; G06F 17/30

(52) U.S. Cl. CPC G06F 11/1088; G06F 17/30194

(57) ABSTRACT

A method for a dispersed storage network (DSN) includes determining a storage/retrieval method including storing/retrieving the data file locally in the set top box as a data file, storing encoded data slices of the data file in set top boxes or storing encoded data slices of the data file in DSN memory. For storing/retrieving in set top boxes or in DSN memory, the set top box sends a subscription request message and determines a storage/retrieval designation to include any of: store locally, store indirect, or store direct; and for a determination of indirect, the set top boxe sends the data file to the DS processing unit; and for direct, determines operational parameters, creates encoded data slices of the data file in accordance with the operational parameters, determines storage locations and sends the encoded data slices to other set top boxes.

### CROSS-REFERENCE TO RELATED APPLICATIONS

The present U.S. Utility Patent Application claims priority pursuant to 35 U. S.C. § 120 as a continuation-in-part of U.S. Utility application Ser. No. 15/956,984, entitled “LARGE SCALE DISPERSED STORAGE NETWORK USING WIRELESS DEVICES AND CENTRALIZED CONTROL,” filed Apr. 19, 2018, which is a continuation-in-part of U.S. Utility application Ser. No. 14/328,904, entitled “DISPERSED STORAGE USING LOCALIZED PEER-TO-PEER CAPABLE WIRELESS DEVICES IN A PEER-TO-PEER OR FEMTO CELL SUPPORTED CARRIER SERVED FASHION,” filed Jul. 11, 2014, now issued as U.S. Pat. No 9,996,548 on Jun. 12, 2018, which is a continuation-in-part of U.S. Utility application Ser. No. 14/230,253, entitled “LARGE SCALE SUBSCRIPTION BASED DISPERSED STORAGE NETWORK,” filed Mar. 31, 2014, now issued as U.S. Pat. No. 9,268,641 on Feb. 23, 2016, which is a continuation of U.S. Utility application Ser. No. 12/862,878, entitled “LARGE SCALE SUBSCRIPTION BASED DISPERSED STORAGE NETWORK,” filed Aug. 25, 2010, now issued as U.S. Pat. No. 8,688,907 on Apr. 1, 2014, which claims priority pursuant to 35 U.S.C. § 119(e) to U.S. Provisional Application No. 61/264,504, entitled “LARGE SCALE DISTRIBUTED STORAGE NETWORK,” filed Nov. 25, 2009, all of which are hereby incorporated herein by reference in their entirety and made part of the present U.S. Utility Patent Application for all purposes.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

### Technical Field of the Invention

This invention relates generally to computer networks and more particularly to dispersing error encoded data.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9 is a schematic block diagram of another embodiment of a dispersed storage system in accordance with the invention;

FIG. 9A is a flowchart illustrating an example embodiment of storing slices in accordance with the invention;

FIG. 9B is a flowchart illustrating another example embodiment of storing slices in accordance with the invention; and

FIG. 9C is a flowchart illustrating another example embodiment of retrieving slices in accordance with the invention.

### DETAILED DESCRIPTION OF THE INVENTION

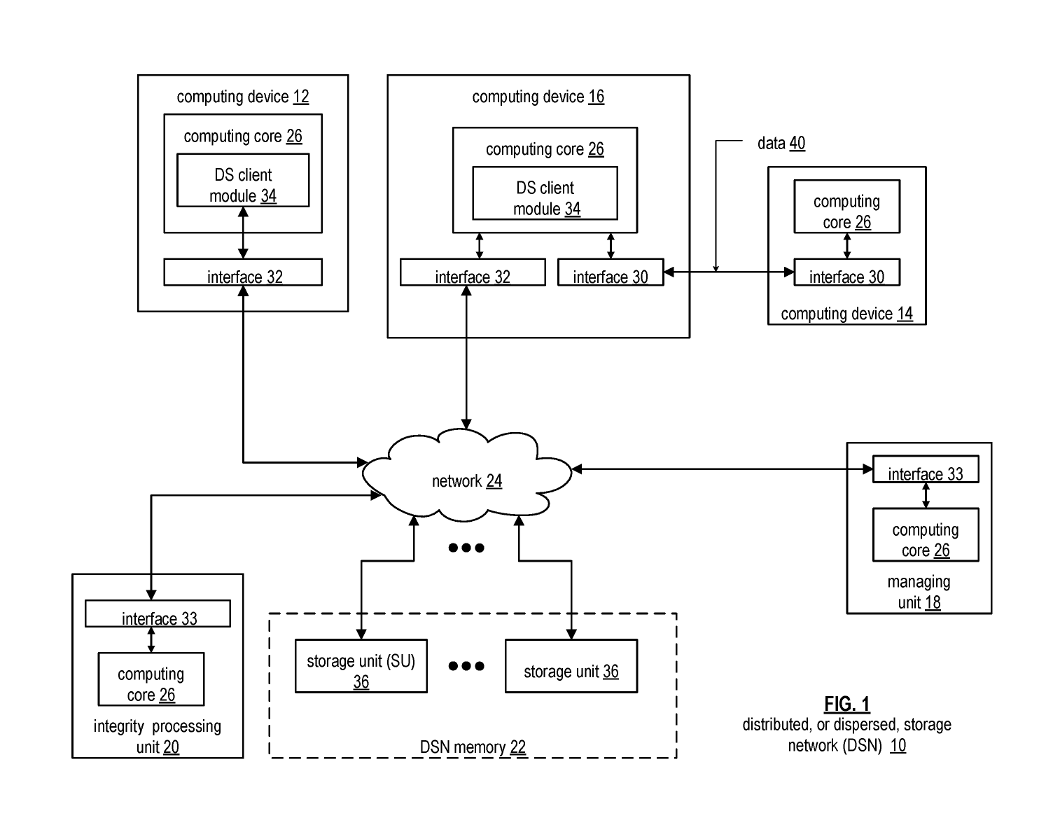

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

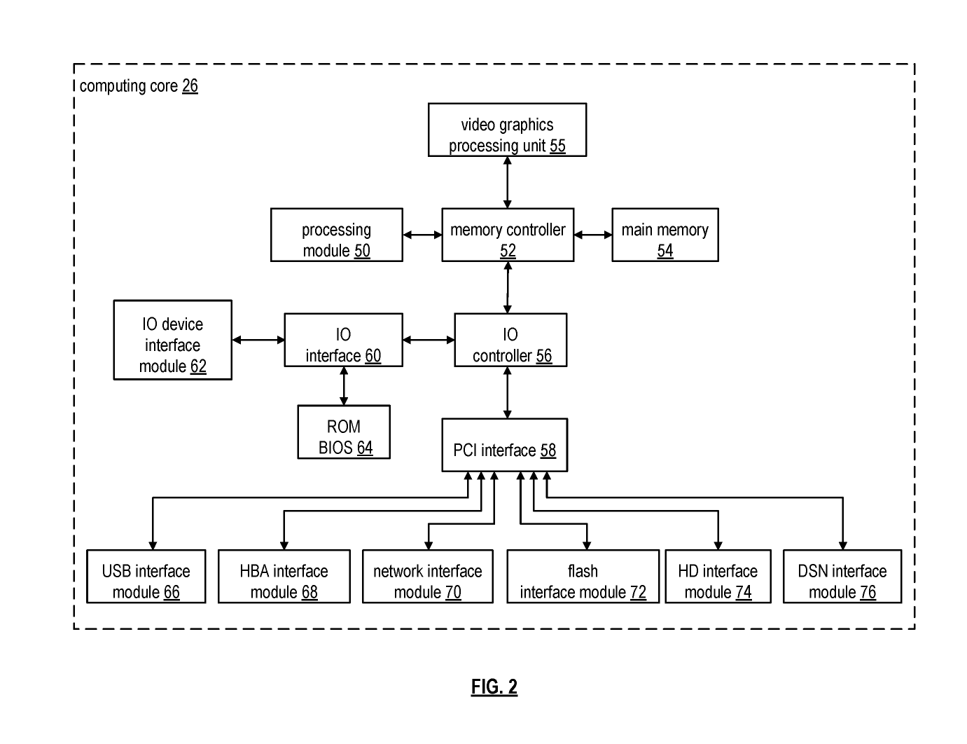

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 & 16 and the DSN memory 22. As yet another example, interface 33 supports a communication link for each of the managing unit 18 and the integrity processing unit 20 to the network 24.

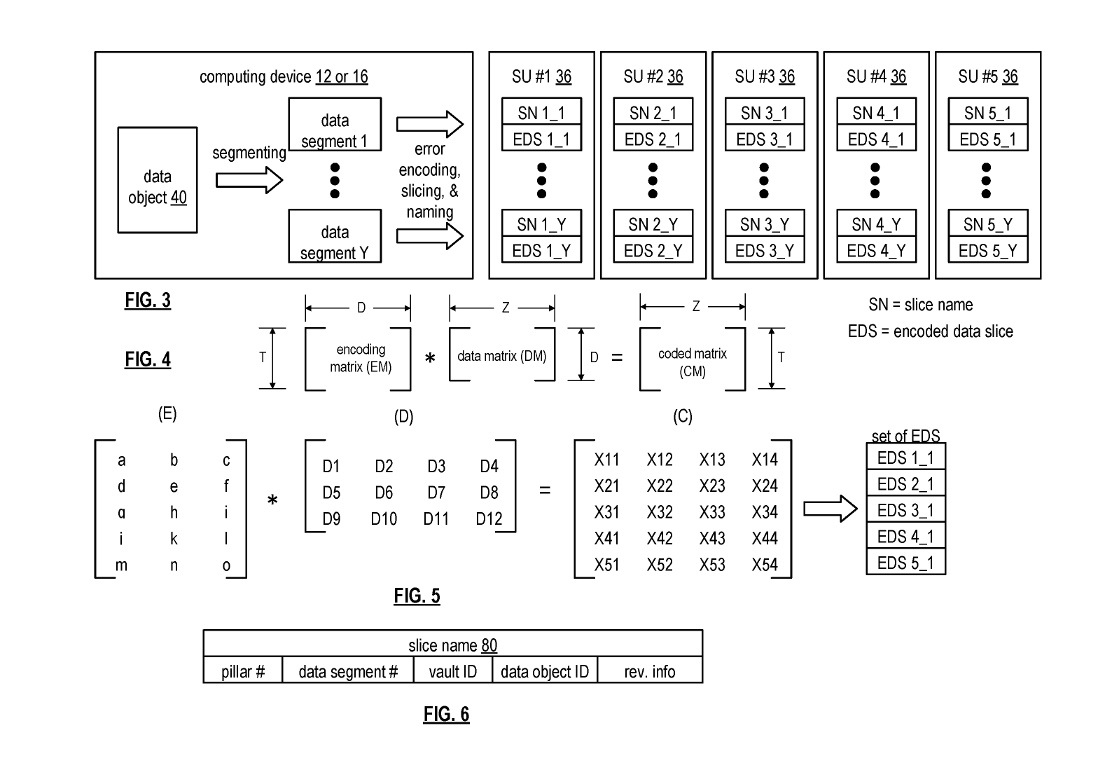

Computing devices 12 and 16 include a dispersed storage (DS) client module 34, which enables the computing device to dispersed storage error encode and decode data as subsequently described with reference to one or more of FIGS. 3-9C. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSTN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The DSN managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The DSN managing unit 18 creates billing information for a particular user, a user group, a vault access, public vault access, etc. For instance, the DSTN managing unit 18 tracks the number of times a user accesses a non-public vault and/or public vaults, which can be used to generate per-access billing information. In another instance, the DSTN managing unit 18 tracks the amount of data stored and/or retrieved by a user device and/or a user group, which can be used to generate per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSTN memory 22.

FIG. 2 is a schematic block diagram of an embodiment of a computing core 26 that includes a processing module 50, a memory controller 52, main memory 54, a video graphics processing unit 55, an input/output (10) controller 56, a peripheral component interconnect (PCI) interface 58, an 10 interface module 60, at least one 10 device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment i.e., in a set of encoded data slices); a decode threshold number (D) of encoded data slices of a set of encoded data slices that are needed to recover the data segment; a read threshold number (R)of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

Returning to the discussion of FIG. 3, the computing device also creates a slice name (SN) for each encoded data slice (EDS) in the set of encoded data slices. A typical format for a slice name 60 is shown in FIG. 6. As shown, the slice name (SN) 60 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

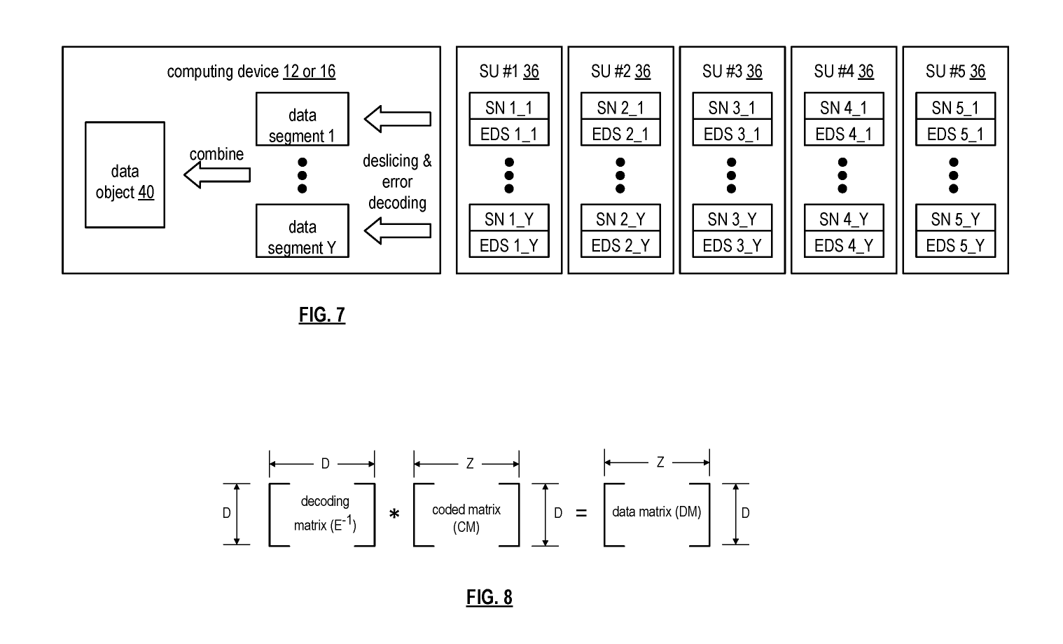

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

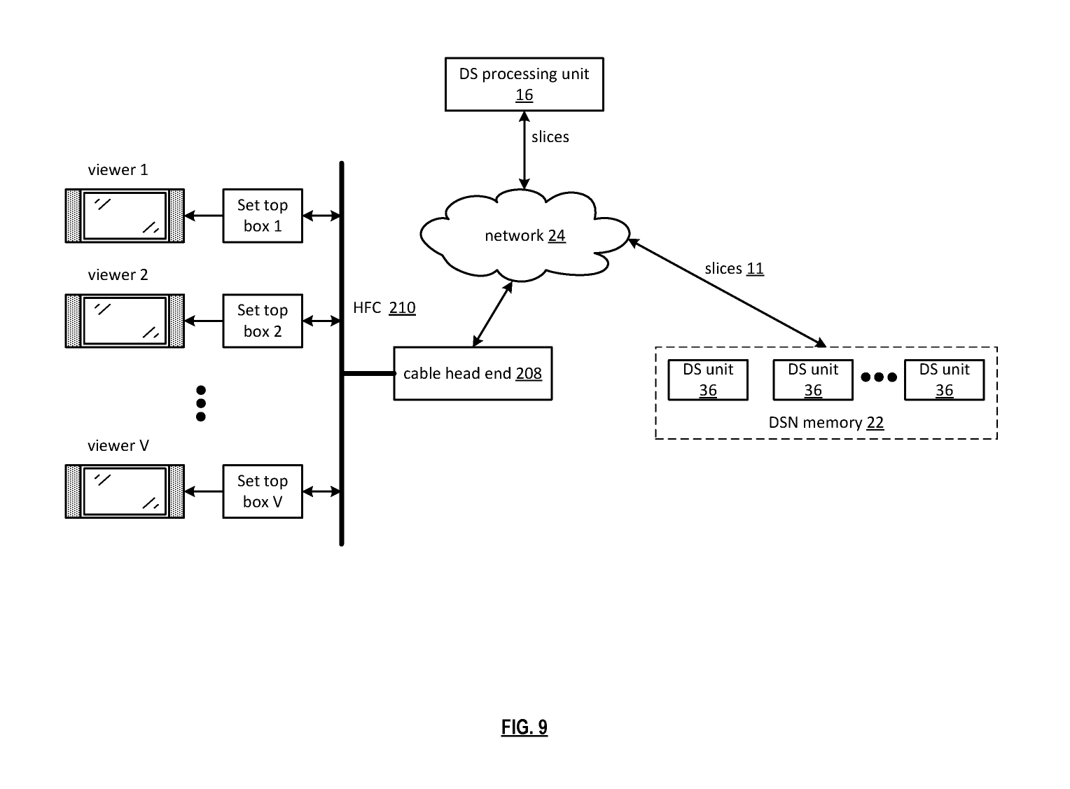

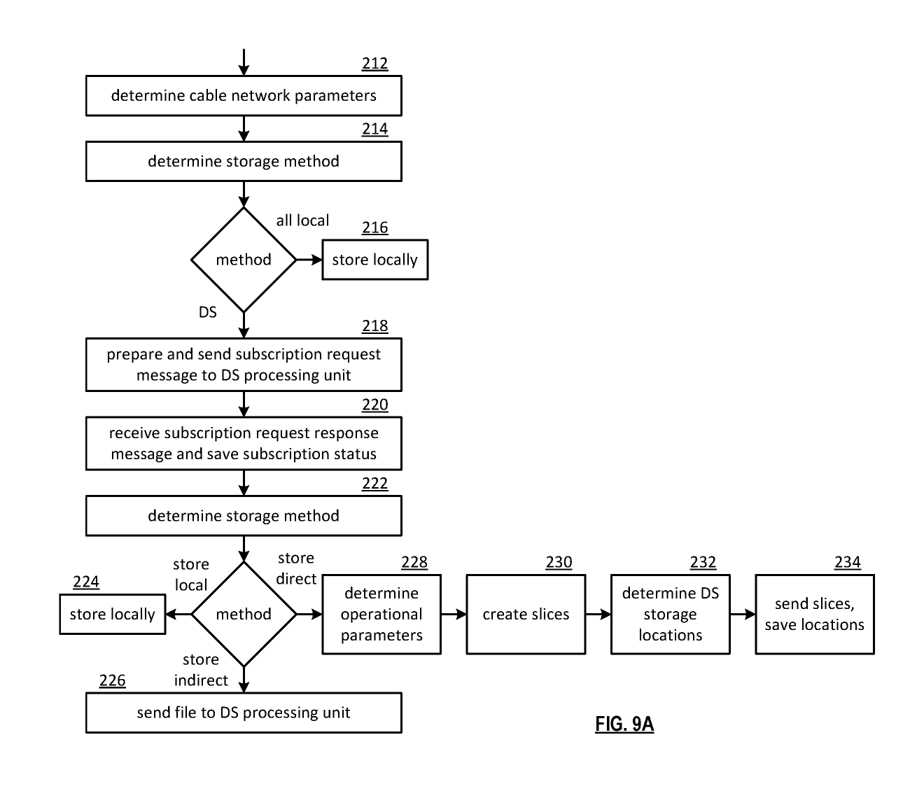

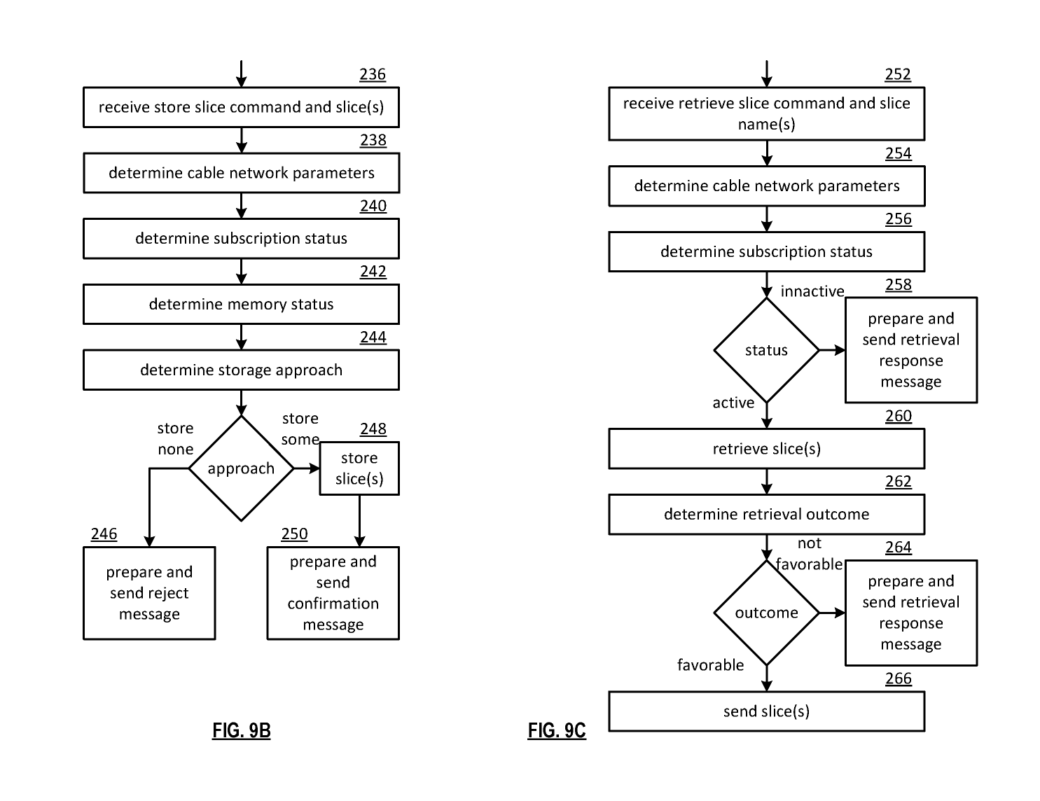

FIG. 9 is a schematic block diagram of another embodiment of a computing system. As illustrated, system includes a DS processing unit 16 (computing device), a network 24, a DSN memory 22, a cable head end 208, a hybrid fiber coax (HFC) distribution 210, a plurality of viewers 1-V, and a plurality of set top boxes 1-V. The DSN memory 22 includes a plurality of DS units 36 (storage units). Note that the system may include two or more DSN memories. The cable head end 208 sources broadcast, multicast, and/or unicast content via the HFC distribution to the plurality of set top boxes 1-V. In another example, a satellite receiving system may substitute the cable head end 208 and/or HFC 210. In yet another example, a content server (e.g., on the internet) and network connection may substitute the cable head end 208 and/or HFC 210.

The set top boxes 1-V may comprise the computing core 26, a memory, and DS processing 34 (DS client module) to transform media into slices for storage and retrieve slices, de-slice, and decode to produce media for viewing. The DS processing may utilize the memory to store content including content in the form of slices. The set top boxes 1-V select content from the cable head end 208 (e.g., broadcast/multicast or on-demand video over cable, satellite and/or the internet), stored content from the memory, stored content in other set top boxes 1-V, and/or content from the DSN memory 22. Note that the set top box may function as a DS unit 36 to store slices 11.

The viewers 1-V may reproduce media (e.g., video, audio, pictures, web content) output from the set top boxes 1-V. For example, the viewers 1-V may comprise a flat panel television and may include a display and speakers to reproduce the media. In another example, the functions of the set top box and viewer are integrated together. In an instance, the viewers 1-V may connect either directly to other viewers 1-V and/or the DSN memory 22 to store and retrieve media slices 11.

The set top boxes 1-V determine which portion of the content to store in memory. For example, the viewer and/or set top box may be operated to record or store in memory the 5:30 pm evening news on cable channel 188 on October 18 such that the viewer may subsequently access the content. The set top boxes 1-V determine which content element (e.g., a portion of content such as a particular show or program) stored in the memory to distributedly store. Such a determination may be based on one or more of a command, a command from the cable head end 208, a command from at least one other set top box, a memory utilization indicator, or a predetermination. For example, the set top boxes 1-V determine to distributedly store a movie when the memory utilization indicator is above a threshold (e.g., indicating that the memory is almost full).

The set top boxes 1-V communicate with the network 24 and may operate in accordance with one or more cable industry standards including but not limited to data over cable service interface specification (DOC SIS). The set top boxes 1-V may be operably coupled to the cable head end 208 through a series of coax cables, connectors, power splitters, amplifiers, fiber that are prone to failures due to many possible causes including weather, construction, landscaping, etc. The set top boxes 1-V may experience degraded or no operation when failures occur in the HFC 210. Note that as a result, the set top boxes 1-V may not be as available (e.g., with network connectivity) as compared to a DSN memory 22 when implemented in a robust information technology (IT) data center. Note that the set top boxes 1-V may experience varying levels of bandwidth connectivity with other set top boxes in the same building, in the same neighborhood, and in the same cable system. Generally, the bandwidth may be higher between set top boxes in closer proximity.

Each of the set top boxes 1-V includes memory to store EC data slices from the set top box and/or other set top boxes 1-V. The size of the memory may be configured to store a predetermined amount of EC data slices. In an example, the memory may be partitioned into at least two portions where a first portion is devoted to storing slices for others and a second portion is devoted to storing data that is not slices for others. Note that the partitioning may be changed from time to time based on one or more of a user input, a command, cable network parameters (e.g., measures of the cable system performance), or a memory utilization indicator (e.g., historical record of actual use). Further note that the set top boxes 1-V may be implemented as a network storage device with a minimum amount of memory portioned for the storing of slices of other set top boxes.

In an example of operation, set top box 2 sends a subscription request to the DS processing unit 16 to subscribe as an active participant in the utilization of the plurality of set top boxes 1-V to store and retrieve error encoded (EC) data slices (slices). The set top box 2 determines to store a data object in one or more of locally (e.g., in the set top box) as a data object file, locally as slices, in other set top boxes 1-V (e.g., set top boxes in the same building, in the same neighborhood, in the same cable system) as slices, directly in the DSN memory 22 as slices, and/or indirectly utilizing the DS processing unit 16 to encode and distribute slices 11 two the DSN memory 22.

In the example, the DS processing unit 16 receives the subscription request from the set top box 2, processes it, and sends a subscription request response to the set top box 2. The response may indicate if the subscription request is granted or not granted. In addition, the response may indicate if the set top box 2 shall send slices directly to other set top boxes 1-V or if the set top box 2 is to send the data object to the DS processing unit 16 for encoding into slices 11 for dispersal. The DS processing unit 16 determines the subscription request response based on one or more of set top box ID, an authentication record (e.g., verification that the set top box is paying for the subscription), a network status indicator (e.g., capacity exists for more slice traffic), or a subscription pool availability indicator (e.g., enough subscribing set top boxes exists to support distributedly storing data). For example, the DS processing unit 16 determines to grant the subscription request and enable direct storing of slices to other set top boxes when the account is paid for the set top box 2 and subscription pool availability indicator status is favorable (e.g., enough capacity exists).

In the example, set top box 15 receives slices from set top box 2 with a store slice command. The set top box 15 determines its subscription status (e.g., previously and still granted permission to participate), memory status (e.g., verification that enough memory is available to store the slices) and the cable network parameters. The set top box 15 determines how much of the slices to store based on one or more of the cable network parameters, the subscription status, the size of the slices, a loading indicator (e.g., is it too busy), or memory status. The set top box 15 stores slices based on the determination. The set top box 15 sends a message to set top box 2 that sent the slices to indicate the status (resolution) of the slices (e.g., stored, not stored).

In another example, the set top box 15 may receive a slice retrieval command from set top box 2 with slice names. Set top box 15 determines the cable network parameters and its subscription status (e.g., previously and still granted permission to participate). The set top box 15 attempts to retrieve the slices when the subscription status is still active. The set top box 15 verifies that the slices are as they were stored (e.g., checksum integrity test). The set top box 15 sends slices to set top box 2 that requested retrieval of the slices when the slice verification is favorable (e.g., as they were originally stored).

In another example of operation, set top box 2 sends a subscription request to the DS processing unit 16 when it has a file to store. The set top box to creates EC data slices of the data file and sends them to set top boxes 3-9 for storage when the DS processing unit 16 grants the set top box 2 the subscription request to send slices directly to other set top boxes and the cable network parameters are favorable to set top boxes 3-9 (e.g., the set top boxes are close to the set top box 2 and the cable system operation is favorable). The subscribing set top boxes 3-9 store the slices they receive from the set top box 2 when they have available memory and when the cable network parameters are favorable. The subscribing set top boxes 3-9 send storage confirmations to the set top box 2 for the slices stored. The set top box 2 saves the locations (e.g., set top box IDs) of the stored slices for use during subsequent retrieval. Set top boxes 3-9 send the slices to the set top box 2 when receiving a retrieval command from set top box 2 and the set top boxes 3-9 have sufficient capacity to execute the retrieval and the cable network parameters are favorable. The set top boxes 1-V method to distribute, store, and retrieve slices is discussed in greater detail with reference to FIGS. 9A-9C.

FIG. 9A is a flowchart illustrating another example of distributing slices. The method begins with step 212 where a set top box determines cable network parameters when the set top box has a data file to store. The cable network parameters may include one or more of cable system architecture, a proximal indicator for other set top boxes (e.g., same building, neighborhood, city, etc.), a set top box affiliation group (e.g., set top box ID list) with the current set top box, access restrictions, average bit rate, peak bit rate, lowest bit rate, estimate sustained bandwidth, connectivity uptime, or network availability. Such a determination may be based on measuring the metrics and/or a lookup of previously stored metrics. In an example, the set top box continuously measures the metrics and saves measurement results in local memory.

At step 214, the set top box determines a storage method where the storage method includes storing the data file locally in the set top box as a data file or storing EC data slices of the data file in set top boxes and/or the DSN memory. Such a determination may be based on one of more of, but not limited to the cable network parameters, a data file type (e.g., video, music, text, etc.), a data file size, a security indicator, a performance requirement (e.g., retrieval latency), a cost requirement, a preference, or a command. For example, the set top box determines to store locally when the cable network parameters fall below desired thresholds. In an example instance, the slices may be difficult to subsequently retrieve if the wireless connectivity is poor. In another example, the set top box determines to store slices in other set top boxes when the cable network parameters indicate other set top boxes with performance parameters above minimum thresholds. The method branches to step 218 when the set top box determines the storage method to include dispersal. The method continues to step 216 when the set top box determines the storage method to be all local. At step 16, the set top box stores the data file locally.

At step 218, the set top box prepares and sends a subscription request message to the DS processing unit when the set top box determines the storage method to be storing EC data slices of the data file in set top boxes and/or the DSN memory. The subscription request message may include one or more of a subscription request command, the set top box ID, the cable network parameters, the data file type, the data file size, the security indicator, the performance requirement (e.g., retrieval latency), the cost requirement, the preference, or a command. The DS processing unit determines a subscription request response based on one or more of the subscription request command, the set top box ID, the cable network parameters, the data file type, the data file size, the security indicator, the performance requirement (e.g., retrieval latency), the cost requirement, the preference, estimated security, estimated performance, estimated cost, estimated memory availability, or a command. The subscription request response may include one or more of subscription approved or not approved, a minimum threshold of operation of the cable network parameters, approved to store slices indirectly by sending the data file to the DS processing unit (e.g., the DS processing unit creates and stores the EC data slices), approved to create and store slices directly to other set top boxes, estimated memory availability (e.g., amount of memory and uptime of the other set top boxes), or the DSN memory. The DS processing unit sends the subscription request response message to the set top box that includes the subscription request response.

At step 220, the set top box receives the subscription request response message and saves the subscription request response as the subscription status. At step 222, the set top box determines a storage method based on the subscription status, the cable network parameters, estimated memory availability, the data file type, the data file size, the security indicator, the performance requirement (e.g., retrieval latency), the cost requirement, the preference, or a command. The storage methods include store locally, store indirect, and store direct. For example, the set top box may determine the store direct method when the subscription status indicates that the set top box was approved to create and store slices directly to other set top boxes, the estimated memory availability for the other set top boxes is greater than the data file size by at least a threshold, and the cable network parameters indicate favorable conditions (e.g., above the minimum threshold). The method branches to step 224 when the set top box determines the storage method to be store local. At step 224, the set top box stores the data file locally in the set top box. The method branches to step 226 when the set top box determines the storage method to be store indirect. At step 226, the set top box sends the data file to the DS processing unit for encoding and disperse storing slices. The method continues to step 228 when the set top box determines the storage method to be store direct.

At step 228, the set top box determines the operational parameters. Such a determination may be based on one or more of the subscription status, the cable network parameters, estimated memory availability, the data file type, the data file size, the security indicator, the performance requirement (e.g., retrieval latency), the cost requirement, the preference, or a command. For example, the set top box determines the operational parameters to include a relatively larger number of pillars (e.g., n=32) with respect to a read threshold with a relatively low number (e.g., 10) when the cable network parameters indicate unfavorable connectivity. In this instance, the set top box chooses operational parameters with improved reliability.

At step 230, the set top box creates EC data slices of the data file in accordance with the operational parameters utilizing an error coding dispersal storage function. At step 232, the set top box determines DS storage locations based on one or more of subscription status, the cable network parameters, estimated memory availability, the data file type, the data file size, the security indicator, the performance requirement (e.g., retrieval latency), the cost requirement, the preference, or a command. For example, the set top box may choose other set top boxes that have the lowest estimated retrieval latencies (e.g., set top boxes in the same building) and best cable network parameters.

At step 234, the set top box sends the EC data slices to the determined storage locations (e.g., other set top boxes) with a store command. The set top box receives confirmation (resolution) of storage messages from the set top boxes that store the slices. The set top box saves the set top box identifiers of set top boxes where the set top box received confirmation of storage messages. The set top box may utilize the set top box identifiers to subsequently retrieve the EC data slices. The set top box methods to store and retrieve slices are discussed in greater detail with reference to FIGS. 9B-9C.

FIG. 9B is a flowchart illustrating another example storing slices. The method begins with step 236 where a set top box receives a store slice command, slice names, slice sizes, a priority indicator, and slices(s) from one or more of the set top box, a DS processing unit, a storage integrity processing unit, a DS managing unit, and/or the DS unit. At step 238, the set top box determines the cable network parameters. The cable network parameters may include one or more of cable system architecture, a proximal indicator for other set top boxes (e.g., same building, neighborhood, city, etc.), a set top box affiliation group (e.g., set top box ID list) with the current set top box, access restrictions, average bit rate, peak bit rate, lowest bit rate, estimate sustained bandwidth, connectivity uptime, or network availability. Such a determination may be based on measuring the metrics and/or a lookup of previously stored metrics. In an example, the set top box is continuously measuring the metrics and saving the measurement results in local memory.

At step 240, the set top box determines a subscription status which indicates whether the set top box is engaged in a subscription as an active subscriber or not. Such a determination may be made by checking the previously saved subscription status from a subscription sequence. At step 242, the set top box determines a memory status of the set top box which indicates if the memory is full or how much storage space is available to accept the received slices. Such a determination may be made by a query of the memory in the set top box and/or by a lookup.

At step 244, set top box determines a storage approach where the approach may include to store at least some of the slices or to store none of the slices. Such a determination may be based on one or more of the cable network parameters, slice sizes, available memory, memory status, the priority indicator, or a set top box activity indicator (e.g., how busy the set top box is). For example, the set top box determines to store none of the slices when the aggregate of the slice sizes is greater than the set top box available memory or if the set top box activity indicator indicates that the set top box is too busy to incrementally process storing slices or if the cable network parameters are unfavorable for reliable subsequent slice retrievals (e.g., the HFC system is too unstable, the cable network parameters do not meet the minimum threshold). The method branches to step 248 when the set top box determines the storage approach to be store some. The method continues to step 246 when the set top box determines the storage approach to be store none. At step 246, the set top box prepares and sends a reject message (resolution) to the storage requester (e.g., the DS processing in another set top box). The reject message includes a list of the slice names not stored such that the requester may determine a next step (e.g., send the slices to another set top box).

At step 248, the set top box stores at least some of the slices in one or more of the local set top box memory and/or another set top box memory. The set top box may update a local virtual DSN address (e.g., slice name) to physical location table with the location of the stored slices to facilitate subsequent retrieval. Note that the slices may be stored locally in the set top box memory and/or in an external memory (e.g., in another set top box and/or the DSN memory). The set top box determines how many of the slices to store based on one or more of the cable network parameters, the slice sizes, the available memory, memory status, the priority indicator, or a set top box activity indicator (e.g., how busy the set top box is). For example, the set top box may store a portion of the slices less than all of the slices when the available memory is not greater than the slice sizes by a threshold. In another example, the set top box may only store the highest priority slices when the cable network parameters are unfavorable.

At step 250, the set top box prepares and sends a confirmation message (resolution) to the storage requester (e.g., the DS processing of another set top box). The confirmation message includes a list of the slice names stored and any slice names that were not stored such that the requester may determine what to do next (e.g., send the not stored slices to another set top box).

FIG. 9C is a flowchart illustrating another example of retrieving slices. The method begins with step 252 where a set top box receives a retrieve slice command, slice names, and a priority indicator from one or more of the set top box, a DS processing unit, a storage integrity processing unit, a DS managing unit, and/or the DS unit. At step 254, the set top box determines cable network parameters. The cable network parameters may include one or more of cable system architecture, a proximal indicator for other set top boxes (e.g., same building, neighborhood, city, etc.), a set top box affiliation group (e.g., set top box ID list) with the current set top box, access restrictions, average bit rate, peak bit rate, lowest bit rate, estimate sustained bandwidth, connectivity uptime, or network availability. Such a determination may be based on measuring the metrics and/or a lookup of previously stored metrics. In an example, the set top box is continuously measuring the metrics and saving the measurement results in local memory.

At step 256, the set top box determines a subscription status which indicates whether the set top box is active in a subscription as a subscriber or inactive. Such a determination may be made by checking the previously saved subscription status from a subscription sequence. For example, the set top box determines the subscription status to be inactive when the cable network parameters are unfavorable even if the set top box is an approved subscriber. The method branches to step 260 when the set top box determines the subscription status to be active. The method continues to step 258 when the set top box determines the subscription status to be inactive. At step 258, the set top box sends a retrieval response message to the retrieval requester (e.g., the DS processing). The retrieval response message includes a list of the slice names not available from this set top box ID such that the requester may determine a next step (e.g., retrieve the same or different pillar slices from another set top box).

At step 260, the set top box retrieves the slices when the set top box determines the subscription status to be active. The set top box determines where to retrieve the slices from based on a lookup in the local virtual DSN address (e.g., slice name) to physical location table. Note that the slices may be stored locally in the set top box memory and/or in an external memory (e.g., in another set top box and/or the DSN memory).

At step 262, set top box determines a retrieval outcome which indicates if the retrieval was favorable (e.g., the slices were still present and the integrity was intact) or unfavorable (e.g., missing slices, corrupted slices, tampered slices). Such a determination may be based on one or more of slice names listed in the local virtual DSN address to physical location table, slices present in memory, or verification of a stored checksum compared to a currently calculated checksum of the slice. The method branches to step 266 when the set top box determines the retrieval outcome to be favorable. The method continues to step 264 when the set top box determines the retrieval outcome to be not favorable. At step 264, the set top box sends a retrieval response message to the retrieval requester (e.g., the DS processing). The retrieval response message includes a list of the slice names not available from this set top box ID such that the requester may determine a next step (e.g., retrieve the same or different pillar slices from another set top box). At step 266, the set top box sends the slices to the requester when the set top box determines the retrieval outcome to be favorable.

The method described above in conjunction with the processing module can alternatively be performed by other modules of the dispersed storage network or by other computing devices. In addition, at least one memory section (e.g., a non-transitory computer readable storage medium) that stores operational instructions can, when executed by one or more processing modules of one or more computing devices of the dispersed storage network (DSN), cause the one or more computing devices to perform any or all of the method steps described above.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for execution by one or more processing modules of a set top box of a dispersed storage network (DSN), the method comprises:
determining cable network parameters when the set top box has a data file to store;
determining a storage method where the storage method includes storing the data file locally in the set top box as a data file or storing error encoded (EC) data slices of the data file in one or more of: set top boxes or DSN memory;
prepare and send a subscription request message to a DS processing unit based on a storage method of storing EC data slices of the data file in one or more of: set top boxes or the DSN memory;
receiving a subscription request response message and saving the subscription request response as a subscription status;
based on an approved subscription status, determining a storage method where the storage method includes storing the EC data slices locally in the set top box or storing error encoded (EC) data slices indirectly or directly in another set top box or in DSN memory;
storing at least some of the EC data slices locally in set top box memory based on the storage method to be stored local;
sending, based on an indirect storage method, the data file to a DS processing unit for encoding and disperse storing of the EC data slices on another set top box or in DSN memory;
creating, based on a direct storage method, EC data slices of the data file, in accordance with operational parameters, utilizing an error coding dispersal storage function;
sending the EC data slices to determined storage locations with a store command;
receiving confirmation of storage messages from the set top boxes that store the slices; and
saving set top box identifiers of set top boxes where the set top box received confirmation of storage messages.

2. The method of claim 1, wherein the cable network parameters include one or more of: a cable system architecture, a proximal indicator for other set top boxes, a set top box affiliation group with a current set top box, access restrictions, average bit rate, peak bit rate, lowest bit rate, estimate sustained bandwidth, connectivity uptime, or network availability.

3. The method of claim 1, wherein the determining the cable network parameters is based on measuring metrics or a lookup of previously stored metrics.

4. The method of claim 3, wherein the set top box continuously measures the metrics and saves measurement results in local memory.

5. The method of claim 1, wherein the determining a storage method is based on one of more of: the cable network parameters, a data file type, a data file size, a security indicator, a performance requirement, a cost requirement, a preference, or a command.

6. The method of claim 1, wherein the determining to store locally includes when the cable network parameters fall below desired thresholds.

7. The method of claim 1, wherein the determining to store slices in other set top boxes includes when the cable network parameters indicate other set top boxes with performance parameters above minimum thresholds.

8. The method of claim 1, wherein the subscription request message includes one or more of: a subscription request command, a set top box ID, the cable network parameters, a data file type, a data file size, a security indicator, a performance requirement, a cost requirement, a preference, or a command.

9. The method of claim 1, wherein the subscription request response message is based on one or more of: a subscription request command, a set top box ID, cable network parameters, a data file type, a data file size, a security indicator, a performance requirement, a cost requirement, a preference, an estimated security, an estimated performance, an estimated cost, an estimated memory availability, or a command.

10. The method of claim 1, wherein the subscription request response includes one or more of: subscription approved or not approved, a minimum threshold of operation of the cable network parameters, approved to store slices indirectly by sending the data file to the DS processing unit, approved to create and store slices directly to other set top boxes, estimated memory availability, or the DSN memory.

11. The method of claim 1, wherein the direct storage method includes the store direct method based on one or more of: the subscription status indicates that the set top box was approved to create and store slices directly to other set top boxes, an estimated memory availability for the other set top boxes is greater than a data file size by at least a threshold, or the cable network parameters indicate favorable conditions.

12. The method of claim 1, wherein the determining the operational parameters is based on one or more of: the subscription status, the cable network parameters, an estimated memory availability, a data file type, a data file size, a security indicator, a performance requirement, a cost requirement, a preference, or a command.

13. The method of claim 1, wherein the determining the operational parameters includes a relatively larger number of pillars with respect to a read threshold with a relatively low number when the cable network parameters indicate unfavorable connectivity.

14. The method of claim 1, wherein the determined storage locations are based on one or more of: subscription status, the cable network parameters, estimated memory availability, a data file type, a data file size, a security indicator, a performance requirement, a cost requirement, a preference, and a command.

15. The method of claim 1, wherein the set top box utilizes set top box identifiers to subsequently retrieve the EC data slices.

16. A method for execution by one or more processing modules of a set top box of a dispersed storage network (DSN), the method comprises:
receiving a store error encoded (EC) data slice command and associated EC data slices;
determining cable network parameters;
determining a subscription status;
determining a set top box memory status;
based on a favorable subscription status and favorable set top box memory status, storing at least some of the EC data slices locally in the set top box memory; and
based on an unfavorable subscription status or an unfavorable set top box memory status, rejecting storing of at least some of the EC data slices locally in the set top box memory; and
preparing and sending a message indicating a resolution on storage of the EC data slices in the set top box memory.

17. The method of claim 16, wherein the message indicating a resolution on storage of EC data slices in the set top box memory includes, for storing of at least some of the EC data slice(s) locally in the set top box, EC data slice names and a set top box ID.

18. A method for execution by one or more processing modules of a set top box of a dispersed storage network (DSN), the method comprises:
receiving, from a requester, a retrieve error encoded (EC) data slice command and associated EC data slice name(s);
determining cable network parameters;
determining a subscription status;
determining set top box memory status;
based on a favorable subscription status and favorable set top box memory status, retrieving and sending, to the requester, at least some of the EC data slices stored locally in the set top box; and
based on an unfavorable subscription status or an unfavorable set top box memory status, rejecting retrieving of at least some of the EC data slices stored locally in the set top box; and
preparing and sending a message indicating a resolution on retrieval of the EC data slices stored in the set top box memory.

19. The method of claim 18, wherein the message indicating a resolution of retrieval of EC data slices stored in the set top box memory includes, for the retrieving of at least some of the EC data slices stored locally in the set top box, a listing of retrieved EC data slice names and a set top box ID.

20. The method of claim 18, wherein the favorable set top box memory status includes the requested EC data slices still being present and their integrity intact and the unfavorable set top box memory status includes missing slices, corrupted slices, tampered slices.
